(19) United States
(12) Patent Application Publication
(10) Pub. No.: US 2026/0092870 A1
(43) Pub. Date: Apr. 2, 2026

(54) METHOD FOR DETERMINING A CENTRAL WAVELENGTH OF A SPECTRAL LINE WITH HIGH ACCURACY AND ASSOCIATED SYSTEM

(71) Applicant: COMMISSARIAT À L'ENERGIE ATOMIQUE ET AUX ENERGIES ALTERNATIVES, PARIS (FR)

(72) Inventors: Jean-Baptiste SIRVEN, PARIS (FR); Kévin TOUCHET, ESPIRA-DE-L'AGLY (FR); Frédéric CHARTIER, FONTENAY-AUX-ROSES (FR)

(21) Appl. No.: 19/112,188

(22) PCT Filed: Sep. 12, 2023
(86) PCT No.: PCT/EP2023/074973

§ 371 Date: Mar. 14, 2025

(30) Foreign Application Priority Data
Sep. 21, 2022 (FR) FR2209545

(51) Int. Cl. G01N 21/71

(52) U.S. Cl. CPC G01N 21/718

(57) ABSTRACT

A method for determining a central wavelength of interest (λc) of a spectral line of interest includes the steps: A) detecting, at a time t1, a first reference measured profile; B) then detecting, at a time t0, a measured profile of interest derived from the sample of interest; C) then detecting, at a time t2, a second reference measured profile derived from a reference source; D) processing the first and second reference measured profiles and processing the measured profile of interest; E) determining a reference position, called intermediate reference position, at the time t0 by interpolation; F determining a value of the central wavelength of interest based on a difference between the positions of interest and intermediate reference positions, on the known value of the reference wavelength and on a linear dispersion (DL) of the spectrometer and of the associated detector.

### CROSS-REFERENCE TO RELATED APPLICATIONS

This application is a National Stage of International patent application PCT/EP2023/074973, filed on Sep. 12, 2023, which claims priority to foreign French patent application No. FR 2209545, filed on Sep. 21, 2022, the disclosures of which are incorporated by reference in their entireties.

### FIELD OF THE INVENTION

The present invention relates to the field of spectroscopy, and more specifically to determining the central wavelength of a spectral line with very high precision.

### BACKGROUND

For some spectroscopy applications, for example, in atomic or molecular spectroscopy, or for determining the isotopic abundance of an element in a sample using an optical method (called LIBRIS (Laser Induced Breakdown self-Reversal Isotopic Spectrometry), see below), high precision is required when determining the value of the central wavelength of a spectral line. The spectral line to be characterized is produced by a light source and can be an atomic or molecular absorption or emission line. An uncertainty of less than 5 pm, or even less than 1 pm, is typically sought for the value of the central wavelength.

This problem has not arisen to date in the field of laser ablation plasma spectroscopy (using LIBS (Laser Induced Breakdown Spectroscopy) or laser induced plasma optical emission spectrometry, LAMIS (Laser Ablation Molecular Isotopic Spectrometry) techniques, etc.), because the width of the observed lines is typically a few tens of pm. Therefore, the wavelength of the lines is usually measured with an uncertainty of around ten pm to a few tens of pm depending on the linear dispersion of the spectrometer that is used. This uncertainty does not affect these techniques because the analysis is carried out based on the intensity of lines generally integrated over a width of the same order, from around ten to a few tens of pm.

Conventionally, the detection system is calibrated in terms of wavelength by means of a reference source emitting known lines, typically a mercury vapor lamp or a hollow cathode lamp. The position of the line to be analyzed and the position of the reference line are identified as pixels on the detector, and the line to be analyzed is determined based on its relative position relative to that of the reference line. The detector comprises at least N pixels Pi aligned in a row, with i varying from 1 to N. When it is 2D then all the pixels of the same column are integrated. For example, the detector is a CCD array, with 2048×512 pixels.

Let λref be the central wavelength of the reference line and λ0 be the wavelength to be determined, Pref be the position of λref identified as pixels of the detector and P0 be the position of λ0 on said detector. Of course, the wavelength λ0 is selected so that it appears on the detector simultaneously at λ0 for the same configuration of the spectrometer. Then:

$$[ 6 ] {λ}_{0} = {λ}_{ref} + ( {P}_{0} - {P}_{ref} ) \cdot DL , \qquad ( 1 )$$

with DL being the linear dispersion of the detection system, typically in pm/pixel.

For various reasons (thermal fluctuations, vibrations, etc.), the spectrometers and the detectors drift very slightly, even in the controlled environment of a research laboratory, which results in wavelength drift. Of course, this drift is even more pronounced in an analysis situation outside a laboratory (in the field, online, using a portable system, etc.). By way of an example, in the case of a 1 m focal array spectrometer with a 2,400 line/mm grating, a variation of only 10⁻³ degrees of the grating angle causes a 10 pm wavelength shift, which is unacceptable for LIBRIS analysis of lithium, for example, where the aim is uncertainty of less than 1 pm in order to obtain an acceptable uncertainty on the isotopic abundance of ⁶Li.

The detection of the reference line and that of the line to be analyzed are carried out sequentially over time. In the most common case, the signal originating from the sample is routed to the detection system by an optical fiber. In order to carry out the two measurements, it is then worthwhile positioning the optical fiber connected to the spectrometer first in order to collect the light flux originating from the reference source and then that originating from the emission to be characterized, or vice versa, which takes a certain amount of time. Typically, these two measurements are separated by a duration that is of the order of one minute, which is sufficient for such drift to occur.

It is therefore impossible to carry out precise LIBRIS measurements without correcting the wavelength drift of the detection system. The problem arises in the same way in atomic spectroscopy where the intention is to precisely measure λ0 by sampling a reference source.

The invention is of particular interest for the LIBRIS method, its principle, as well as the principle of the LIBS and LAMIS methods, is provided hereafter by way of a reminder.

The principle of LIBS technology, illustrated in FIG. 1, is to focus a laser pulse on the surface of a material sample (or material) in order to generate a transient plasma whose light emission is analyzed by means of a spectrometer. By collecting the emission of light from the plasma and analyzing the spectrum using spectrometry, it is possible to identify the elements present in the plasma, and therefore to determine the composition of the material, based on the transmission line databases. For LIBS, the intensity across the entire width of the line is integrated.

The LAMIS technology, for example, described in the publication by R. Russo et al., in Spectrochim. Acta B 66(2011) 99, is an alternative, derived from LIBS, that allows an isotopic analysis to be carried out based on the lines of the molecules formed by a reaction between the ablated material and a constituent element of the ambient medium, or by a reaction between two atoms of the ablated material.

A laser generator L0 generates a laser beam FL0 that is focused on the sample 1 by virtue of a first optical system 2. This generates a plasma PI0. The plasma emits a light emission 3 that is collected by an optical system OS0. The focused light emission is sent to a spectrometer Spec0 by means of an optical fiber F0. The spectrometer Spec0 comprises (or is associated with) a detector Det0 synchronized with the laser generator L0. The spectrometer Spec0 allows line spectra to be recorded. Finally, processing means UTO are used to process the recorded spectra.

LIBS allows a spectrum 20 to be generated that is in the form of a set of spectral lines that correspond to the emission lines of the elements forming the material, and allows, using the available correlation data between the emission lines and the elements, the elementary composition of the material sample to be determined. The wavelength λ of a line provides information concerning an element present in the material and the intensity I is connected to the concentration of this element.

LIBS emission spectrometry also applies to isotopic analysis because the atomic lines of various isotopes of the same element are at slightly different wavelengths. This spectral shift, called isotopic shift, is due to mass effects (mainly for light elements) and to the modification of the distribution of charges inside the core (mainly for heavy elements). When intending to carry out this isotopic analysis using LIBS it is essential that the lines of the 2 isotopes are separated. However, this spectral shift is generally of the order of a fraction of nm or even a few pm, as shown in Table I below:

TABLE I

| Isotopes | Emission line | Isotopic shift | |
|---|---|---|---|
| 7Li → 6Li | 670.775 nm | +15.8 | pm |
| 10B → 11B | 208.891 nm | −2.5 | pm |
| 238U → 235U | 424.437 nm | +25 | pm |
| 239Pu → 240Pu | 594.522 nm | +13 | pm |

Such a shift is difficult to observe in a plasma generated by laser ablation under normal conditions, because the confinement of the plasma by ambient air at atmospheric pressure results in a high density, and therefore a broadening of the emission lines due to the Stark effect. This broadening commonly reaches several tens or even hundreds of pm and consequently masks the isotopic shift, even if the spectrometer that is used has sufficient spectral resolution for overcoming this shift. In this case, the limitation is physical and is not instrumental.

A first solution involves carrying out the analysis at reduced pressure, or even in a vacuum. By thus limiting the confinement of the plasma by the ambient medium, its density is reduced and sufficient spectral selectivity can be found for some isotopes. A double line is seen, and the isotopic ratio is determined based on the intensity ratio between the two lines associated with the two isotopes. This approach is not applicable to all isotopes and requires a high resolution, and therefore bulky, spectrometer. A second solution involves sending a second laser beam through the plasma, in order to measure a resonant or fluorescence absorption signal, thereby limiting and complicating the measurement system.

In the prior art of isotopic analysis at atmospheric pressure, it is also possible to also use the LAMIS technique, but this assumes meeting several conditions: 1. Molecules must form in the plasma; 2. They must be stable enough under the temperature/density conditions of the plasma; 3. They must have detectable lines, i.e., with a sufficient lifetime, sufficiently intense, and in the spectral band of the detection system. In the case of lithium, for example, no LAMIS signal is detected, probably because the 2^{nd} condition is not met.

The LIBRIS technique is an optical technique for determining the isotopic abundance of an element in a sample (solid, liquid or gaseous) based on the emission spectrum of a laser ablation plasma. This technique is described, for example, in the publication by K. Touchet et al., in Spectrochim. Acta B 168(2020) 105868 and in document US 2019/0041336. It is a variant of LIBS technology and uses the same optical system. LIBRIS technology allows the various disadvantages of the LIBS method to be overcome by allowing measurement of an isotopic ratio at atmospheric pressure and without a second laser.

By way of a reminder, the electron transitions of the atoms to higher energy levels require energy input. This energy can be in the form of photons, in this case the photons are absorbed by the atom. A particular case is that of laser ablation plasma. For the sake of simplification, it is possible to consider that the plasma is made up of two distinct parts, the core and the periphery. Photons emitted by the core of the warmer plasma can be absorbed by the colder periphery. This phenomenon therefore prevents a certain number of emitted photons from exiting the plasma: this is the self-absorption phenomenon.

For an observer outside the plasma, and for a measurement apparatus, the profile of the lines results from the emission and the self-absorption at the same wavelength corresponding to the electron transitions between two levels of all the considered atoms placed on its line of sight. Consequently, the measured intensity is not only the sum of all the emissions of the plasma, as this self-absorption needs to be taken into account.

The self-absorption phenomenon, which is well known in plasma spectroscopy for the elementary analysis, is more considered to be an undesirable phenomenon because it results in a distortion of the profile of the line, and therefore in non-linearity of the signal relative to the concentration of the element of interest. LIBRIS uses this self-absorption effect to derive information concerning the isotopes of a given element in a material.

FIGS. 2 and 3 illustrate a line RSO of an element of interest, selected from a spectrum 20, obtained in two scenarios, depending on the concentration of the element in the material.

FIG. 2 illustrates the scenario whereby the concentration of the element in the plasma is lower, the self-absorption phenomenon is scarcely discernible or is even absent. A spectrally wide line profile is obtained, without a trough in the center thereof. The dotted and dashed curves ISO₁ and ISO₂ represent the emission of the 2 isotopes. The width of each line is significant in view of the difference between the 2 lines, mainly due to the Stark effect in the plasma, and for this reason they are not distinguished individually: the line is detected as a solid line RSO, which corresponds to the sum of the 2. The principle of LIBRIS is that the central wavelength of the line as a solid line varies with the isotopic abundance, i.e., with the ratio of the amplitudes of the 2 dotted and dashed lines. In this case, the value of the central wavelength λ0 corresponding to the emission peak is measured, i.e., the maximum point or vertex 20 of the observed curve that assumes a bell profile. It is correlated with the ratio between two isotopes Iso₁ and Iso₂ of the considered element, and it is shifted as a function of said isotope ratio.

FIG. 3 illustrates the case where the element is highly concentrated in the plasma, the self-absorption phenomenon is then discernible. A line profile with a trough in the center thereof can be seen (double bell profile), called inverted line, resulting from overlaying a spectrally wide emission profile with a spectrally narrower absorption profile. In this case, the value of the central wavelength λ0 corresponding to the absorption trough is measured. In this case, the central wavelength λ0 is measured on the portion of the profile corresponding to the absorption, i.e., at the minimum point 30 of the observed trough. It is correlated with the ratio between two isotopes Iso₁ and Iso₂ of the considered element, and it is shifted as a function of said isotope ratio. It is this wavelength measurement of the trough that defines the LIBRIS technology.

Thus, in LIBRIS technology, the isotope ratio is measured based on the very precise measurement of the wavelength λ0, the maximum bell line or minimum of the line, called inverted line, in a double bell. This wavelength λ0 shifts linearly with the isotopic abundance, between λ_{R}¹ and λ_{R}², with the indices 1 and 2 referring to two isotopes of the element. λ_{R}¹ and λ_{R}² are physical data available in spectroscopic databases and/or in scientific publications. The analytical uncertainty concerning the isotopic abundance is therefore directly related to the uncertainty in determining the wavelength λ0.

In LIBRIS technology, measuring λ0 directly yields the isotope ratio. FIG. 4 illustrates this evolution of λ0 measured as a function of the proportion of the lithium-⁶Li isotope, which has only two ⁶Li and ⁷Li isotopes. This curve has been generated on an inverted line. The isotopic shift is provided by λ_{R}¹−λ_{R}² and corresponds to the extent of measurement of the technique for a given line. In the case of lithium and for the 670.778 nm line used in LIBRIS, this shift is 15.8±0.3 pm and therefore corresponds to the total variation of the isotopic abundance of ⁶Li from 0% to 100%, with any supplement being the abundance of ⁷Li. Thus, an uncertainty of 1 pm in determining the wavelength λ_{R} results in uncertainty concerning the isotopic abundance of 1/15.8=6.3%. The measurement precision of the isotope ratio is therefore directly correlated with the precision of the measurement on λ0.

### SUMMARY OF THE INVENTION

An aim of the present invention is to overcome the aforementioned disadvantages by proposing a method and a system for determining the central wavelength of an atomic or molecular absorption or emission line, produced by a light source, with sub-picometric precision.

The aim of the present invention is a method for determining a central wavelength of interest of a spectral line of interest measured by a spectrometer, the spectral line of interest corresponding to an emission or an absorption of a sample to be characterized, the spectral line of interest having either a bell profile, with said central wavelength of interest then corresponding to the vertex of said bell profile, or a double bell profile, with said central wavelength of interest then corresponding to the trough between the two bells, the spectrometer being associated with a detector comprising a plurality of pixels aligned in a direction X, the spectral line of interest being detected on pixels of the detector, the method comprising the following steps of:
A detecting, at a time t1, a first reference measured profile derived from a reference source having a reference spectral line having a central wavelength, called reference central wavelength, of known value, the reference wavelength being selected so as to be detected on at least one pixel of the detector;
B then detecting, at a time t0, a measured profile of interest derived from said sample of interest;
C then detecting, at a time t2, a second reference measured profile derived from a reference source;
D processing said first and second reference measured profiles so as to determine a first and a second reference position of the reference wavelength, and processing the measured profile of interest so as to determine a position of interest of the central wavelength;
E determining a reference position, called intermediate reference position, at the time t0 by interpolation, based on the first and second reference positions, and based on a linear variation law of the reference position as a function of time between the times t1 and t2;
F determining a value of the central wavelength of interest based on a difference between said positions of interest and intermediate reference positions, on said known value of the reference wavelength and on a linear dispersion of the spectrometer and of the associated detector.

According to one embodiment, the variation law is linear.

According to one embodiment, the processing step D comprises a sub-step of adjusting values of the measured profile of interest and the first and second reference measured profiles with known mathematical functions so as to determine said position of interest and said first and second reference positions by interpolation, with precision of less than one pixel, with the intermediate reference position then also being determined with precision of less than one pixel.

According to one embodiment, the light signal originating from the sample is pulsed.

According to one embodiment, the light signal originating from the sample originates from an emission of a plasma emitted by the sample illuminated by a pulsed laser.

According to one embodiment, the method according to the invention is adapted to determine an isotopic abundance of an element present in said sample, said central wavelength of interest corresponding to a line resulting from the contributions of two isotopes of said element, with said value of the central wavelength of interest allowing said abundance to be determined.

The invention also relates to a system for measuring a central wavelength of interest of a spectral line of interest measured by a spectrometer, the spectral line of interest corresponding to an emission or an absorption of a sample to be characterized, the spectral line of interest having either a bell profile, with said central wavelength of interest then corresponding to the vertex of said bell profile, or a double bell profile, with said central wavelength of interest then corresponding to the trough between the two bells, the measurement system comprising:
a detection system comprising a spectrometer (Spectro) associated with a detector (Det) comprising a plurality of pixels (Pi) aligned in a direction X, the spectral line of interest being detected on pixels of the detector;
the system being configured so that the detector detects:
   at a time t1, a first reference measured profile derived from a reference source, the reference source having a reference spectral line having a central wavelength, called reference central wavelength, of known value, the reference wavelength being selected so as to be detected on at least one pixel of the detector;
   then, at a time t0, a measured profile of interest derived from said sample of interest;
   then, at a time t2, a second reference measured profile derived from the reference source;
the system further comprising a processing unit configured to:
   process said first and second reference measured profiles so as to determine a first and a second reference position of the reference wavelength, and process the measured profile of interest so as to determine a position of interest of the central wavelength;
   determine a reference position, called intermediate reference position, at the time t0 by interpolation, based on the first and second reference positions, and based on a linear variation law of the reference position as a function of time between the times t1 and t2;
   determine a value of the central wavelength of interest based on a difference between said positions of interest and intermediate reference positions, on said known value of the reference wavelength and on a linear dispersion of the detection system.

According to one embodiment, the measurement system according to the invention is adapted for measuring the isotopic abundance of an element present in the sample, and further comprises:
a pulsed laser configured to illuminate the sample so as to generate a plasma able to emit said light signal originating from the sample;
an optical fiber configured so that the input collects either a light signal originating from the sample or a light signal originating from the reference source, and the output is coupled to an input of the spectrometer;
   with the processing unit being configured to synchronize the detector with the laser when detecting the measured profile of interest, said central wavelength of interest corresponding to a line resulting from the contributions of two isotopes of said element, with said value of the central wavelength of interest allowing said isotopic abundance to be determined.

Finally, the invention relates to a computer program comprising instructions that result in the system according to the invention executing the steps of the method according to the invention.

The following description describes several embodiments of the device of the invention: these examples by no means limit the scope of the invention. These embodiments describe both the essential features of the invention and additional features related to the considered embodiments.

### BRIEF DESCRIPTION OF THE DRAWINGS

The invention will be better understood, and further features, aims and advantages thereof will become apparent, from the following detailed description and with reference to the appended drawings, which are provided by way of non-limiting examples and in which:

FIG. 1, already cited, illustrates the measurement principle using LIBS, LAMIS and LIBRIS technologies;

FIG. 2, already cited, illustrates a spectral line measured in a case where there is a low concentration of the element in the plasma, the self-absorption phenomenon is then scarcely discernible or is even negligible;

FIG. 3, already cited, illustrates a spectral line measured in a case where there is a high concentration of the element in the plasma, the self-absorption phenomenon is then discernible;

FIG. 4, already cited, illustrates the evolution of the central wavelength λ0 measured as a function of the isotopic abundance of the lithium-⁶Li isotope in the sample:

FIG. 5 illustrates the method according to the invention;

FIG. 6 illustrates the measured profile of interest PSech, the first reference measured profile PS1ref and the second reference measured profile PS2ref, the first reference theoretical profile PST1ref, the second reference theoretical profile PST2ref and the theoretical profile of interest PSTech;

FIG. 7 illustrates the system according to the invention;

FIG. 8 illustrates the system according to the invention adapted to measure an isotope ratio of an element present in the sample;

FIG. 9 illustrates the data obtained by repeating the measurement 17 times (measurements i numbered from 1 to 17). For each measurement i, on the one hand, a rough value λcₑ(i) (cross) and, on the other hand, a corrected value λc(i) (dots), are determined according to the method 100 according to the invention;

FIG. 10 shows the average and the standard deviation α of these 17 measurements in both cases, rough and corrected with λref of the HCL lamp, respectively (λ_{B}m, σ_{B}) and (λ_{c}m, σ_{c}).

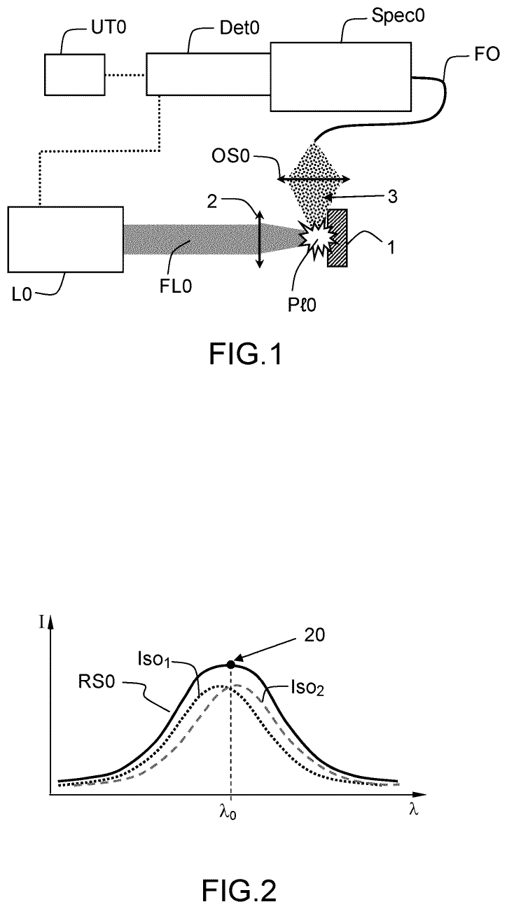

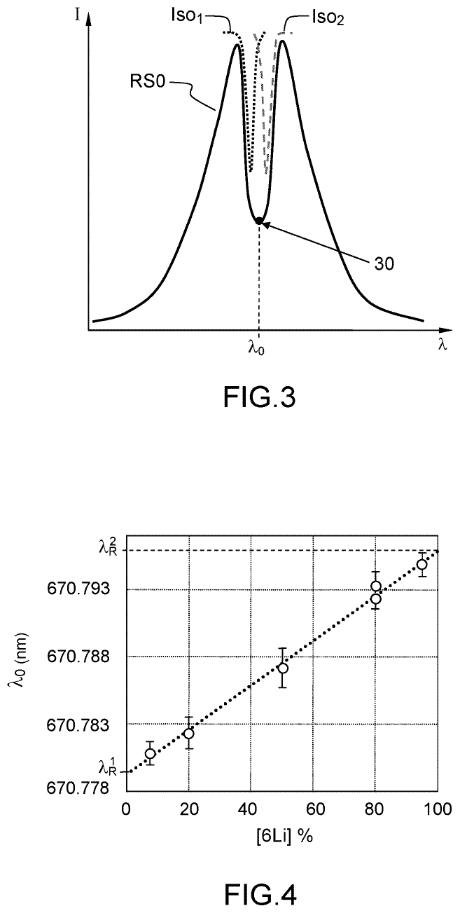

### DETAILED DESCRIPTION

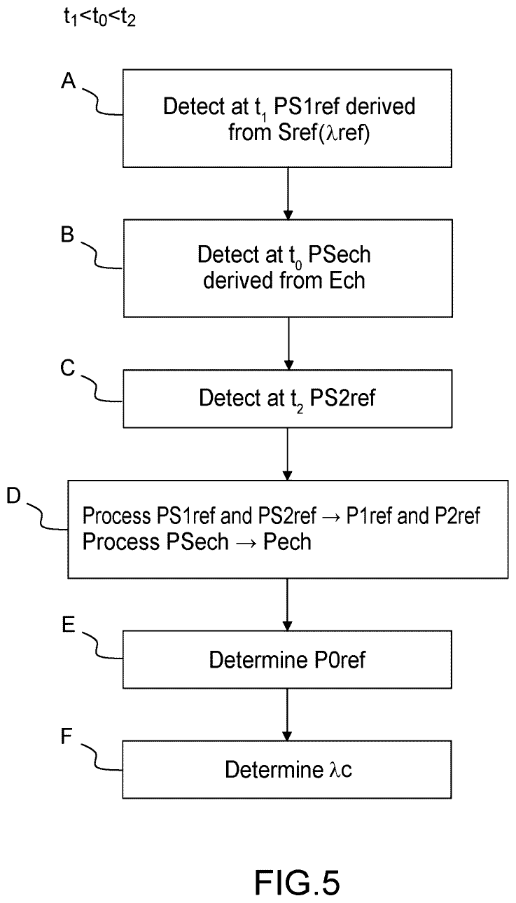

The invention relates to a method 100 for measuring the central wavelength of interest λc of a spectral line of interest RSe measured by a spectrometer, illustrated in FIG. 5. The invention also relates to a system 10 for measuring a central wavelength.

The spectral line of interest corresponds to an emission or an absorption of a sample Ech to be characterized and has either a bell profile, with λc then corresponding to the wavelength of the vertex of the bell profile, or a double bell profile, with λc then corresponding to the wavelength of the trough between the two bells.

The spectrometer carrying out the measurement comprises (or is associated with) a detector Det comprising a plurality of pixels Pi, with i being a pixel index varying from 1 to N, aligned in a direction X. The spectral line of interest RSe is detected on pixels of the detector Det.

In a first step A of the method 10 according to the invention, a first reference measured profile PS1ref derived from a reference source Sref with a reference spectral line RSref with a central wavelength, called reference central wavelength, of known value λref is detected at a time t1. The reference wavelength is selected so as to be detected on at least one pixel of the detector Det. In order to detect and generate the measured spectral profile PS1ref, a light signal SL1ref originating from the source Sref is injected at the input of the spectrometer Spectro. The reference source is selected as a function of the spectral features of the sample to be analyzed.

The measured spectral profile PS1ref is a set of measurement points indexed according to the pixels Pi of the detector, and each index i is associated with a detected intensity I1i.

Then, in a step B, a measured profile of interest PSech derived from the sample to be characterized is detected at a time t0 (that is, t0>t1). To this end, a light signal SLech originating from the sample Ech is injected at the input of the spectrometer Spectro. The measured spectral profile PSech is a set of measurement points indexed according to the detector pixels, and each index j is associated with a detected intensity I0j.

The source Sref is selected so that the line RSref is detected by the detector without modifying the adjustment of the spectrometer associated with the detection of RSe. According to one embodiment, the pixels of the detector detecting the line RSe can be located in a zone of the detector different from that detecting the line RSref. According to another embodiment, the lines RSref and RSe are located at the same location on the detector. It is then advisable for the reference source to be switched off when measuring the sample or to ensure that SLref is negligible in view of SLech.

Then, in a step C, a second reference measured profile PS2ref derived from the reference source Sref is detected at a time t2 (that is, t2>t1). To this end, a light signal SL2ref originating from the source Sref is again injected at the input of the spectrometer Spectro.

The measured profiles PS1ref and PS2ref correspond to the spectral line RSref measured at two different instants t1 and t2, with these two instants framing a measurement of the spectral line of interest RSe. Thus, t1<t0<t2: the detector Det sequentially detects, over time, the signal originating from the reference source at t1, the signal originating from the sample at t0 and again the signal originating from the reference source at t2.

In a step D, the first and second reference measured profiles PS1ref and PS2ref are processed, so as to determine a first reference position P1ref of the reference wavelength λref and a second reference position P2ref of the reference wavelength. These two positions are measured as pixels of the detector, with the index i forming the abscissa of the detected spectrum. In step D, the measured profile of interest PSech is also processed so as to determine the position of interest Pech of the central wavelength λc, still measured as pixels of the detector.

The wavelength drift of the detection system [spectrometer+detector] is measured by the difference (P2ref−P1ref).

In a step E, the reference position P0ref is determined at the time t0 Pref (t0), called intermediate time, by interpolation, based on P1ref, P2ref and on a linear variation law of the reference position as a function of the time Pref(t) between the times t1 and t2.

Finally, in a step F, a value of the central wavelength of interest λc is determined based on the difference between Pech and P0ref, the known value of the reference wavelength λref and the linear dispersion DL of the detection system [spectrometer+detector](typically in pm/pixel).

Typically, the following formula is available:

$$[ 66 ] {λ}_{c} = {λ}_{ref} + ( {P}_{ech} - P {0}_{ref} ) \cdot DL \qquad ( 1 )$$

Of course, the value DL corresponding to the spectral region in which λref and λ0 are located should be taken.

With the method according to the invention, the position of the reference wavelength is more precisely determined as pixels of the detector, taking into account the drift of the detection system, by establishing a linear variation law of the reference position as a function of time. This allows λc to be determined with improved precision compared to a measurement that would only take into account P1ref (measurement of the reference prior to the measurement of the spectrum of interest) or P2ref (measurement of the reference after the measurement of the spectrum of interest). With the method according to the invention, very low uncertainty is obtained concerning the value of λc.

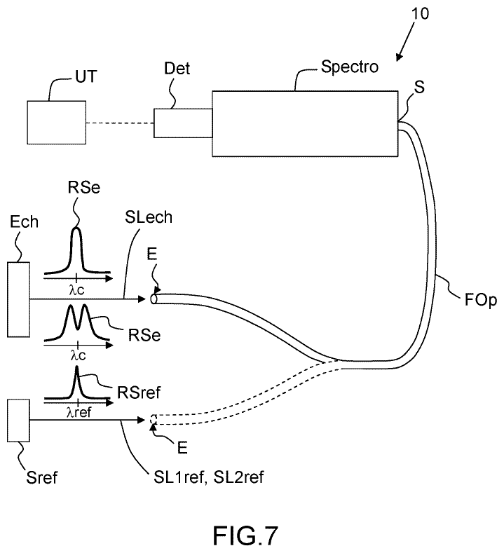

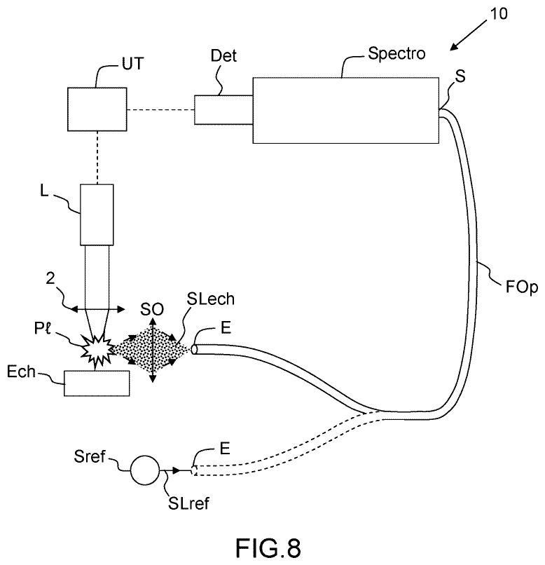

According to a preferred embodiment, the time difference between the two measurements of the spectrum of Sref is low, typically of the order of one minute or less. A low time between the two measurements of the spectrum Sref guarantees a reproducible linear variation between t1 and t2. Indeed, in order to practically carry out the measurement, the input of an optical fiber FOp is moved, the output of which is coupled to the input of the spectrometer Spectro, so as to collect either the light signal originating from the source Sref (SL1ref for the first measurement and SL2ref for the second measurement), or the light signal SLech originating from the sample to be characterized (see FIGS. 7 and 8 hereafter). The time for completing this task, to which the spectrum registration time is to be added, is typically less than one minute.

For a linear drift of Pref(t), then:

$$[ 71 ] {P}_{ref} ( {t}_{0} ) = {( P 0 )}_{ref} = a \cdot {t}_{0} + b \qquad ( 2 )$$

The parameters a and b are determined based on measurements at times t₁ and t₂:

$$[ 73 ] a = \frac{{P}_{ref} ( {t}_{2} ) - {P}_{ref} ( {t}_{1} )}{{t}_{2} - {t}_{1}} = \frac{P {2}_{ref} - P {1}_{ref}}{{t}_{2} - {t}_{1}} \qquad ( 3 )$$

$$[ 74 ] b = {P}_{ref} ( {t}_{2} ) = a \cdot {t}_{2} \qquad ( 4 )$$

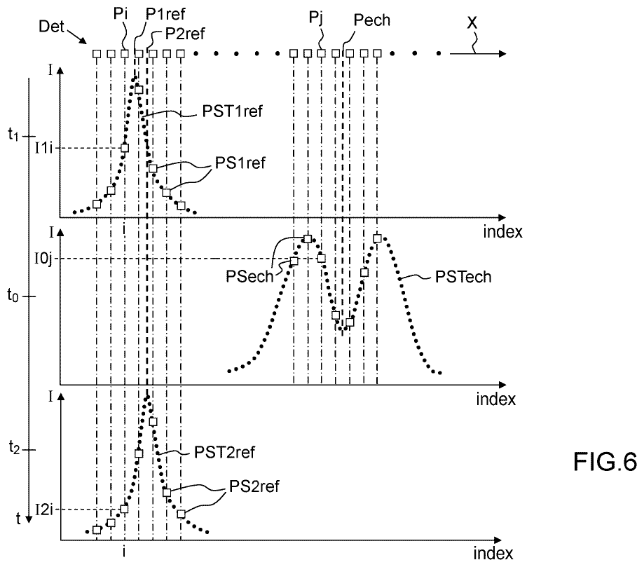

The detector Det sequentially detects the first reference signal, the signal of interest and the second reference signal over time. This detection generates a first reference measured profile PS1ref, a measured profile of interest PSech, and a second reference measured profile PS2ref, as illustrated in FIG. 6. The abscissa of the profiles is the index i of the pixels Pi of the detector and the ordinate is an intensity detected for each pixel, respectively I1i, I0i and I2i.

In order to be able to measure λc with very high precision, the intention is to obtain its position Pech with better precision than the pixel of the detector, i.e., measured as a fraction of the integer index i; likewise, for the positions P1ref and P2ref. To this end, according to one embodiment, the processing step D comprises the sub-step of adjusting the values of the reference measured profiles PS1ref and PS2ref and of the measured profile of interest PSech with known mathematical functions, so as to determine the positions of interest and the reference positions by interpolation, with precision of less than one pixel, as illustrated in FIG. 6.

Thus, theoretical profiles are determined, the first theoretical reference profile PST1ref, the second theoretical reference profile PST2ref and the theoretical profile of interest PSTech, also illustrated in FIG. 6, which adjust with the experimental points as well as possible. Typically, the mathematical functions that are used are selected from among the following: Gaussian, Lorentzian, Voigt.

FIG. 6 shows that without this adjustment the determined positions would correspond to the pixel k of the maximum of the measured spectrum. It is then not possible to have wavelength precision that is better than the interval between two adjacent pixels. By virtue of these theoretical profiles, the positions P1ref, P2ref and Pech are determined as a fraction of pixels (typically with precision to two decimal places) and the precision is greatly improved.

According to one embodiment, the light signal originating from the sample SLref is pulsed. Preferably, the light signal originating from the sample SLech originates from an emission of a plasma emitted by the sample illuminated by a pulsed laser.

According to one embodiment, the method according to the invention is associated with the implementation of LIBRIS technology, i.e., it is adapted to precisely measure an isotopic ratio of an element present in the sample Ech. The light signal SLech originates from an emission of a plasma PI emitted by the sample Ech, illuminated by a pulsed laser L. The central wavelength of interest corresponds to a line resulting from the contributions of two isotopes of the element, and the precise value of the central wavelength of interest λc allows the isotope ratio to be determined, as explained above. Preferably, in step B, the detector Det is synchronized with the laser L.

The system 10 according to the invention is illustrated in FIG. 7. It comprises a spectrometer Spectro associated with the detector Det, which comprises a plurality of pixels Pi aligned in a direction X. Typically, the detector is of the intensified CCD type. An example is i, which is a pixel index varying from 1 to 2,048. When the detector is preferably an array, the intensities are summed in the vertical direction of the columns.

The system is also configured so that the detector Det detects, at a time t1, the first reference measured profile PS1ref derived from the reference source Sref, then, at a time t0, the measured profile of interest PSech derived from said sample of interest, then, at a time t2, the second reference measured profile PS2ref derived from the reference source Sref. To this end, according to one embodiment illustrated in FIG. 7, the input E of an optical fiber FOp is moved as a function of the signal that is intended to be detected, then the measurement is performed with the spectrometer.

The system further comprises a processing unit UT configured to implement steps D, E and F.

The source Sref is selected as a function of the wavelength λc of interest: indeed, λref needs to be close enough to λc so that the two wavelengths can be detected on the detector without changing the adjustment of the spectrometer. Typically, Sref is a hollow cathode lamp, which continuously emits a few photons. With the signal originating from the sample typically being strong and short, the acquisition parameters of the detection system in this case are different for the detection of the two signals (originating from the reference and the sample).

These parameters are (non-exhaustive list): the delay of the measurement relative to the laser shot (for the sample signal only), the width of the acquisition temporal gate, the number and rate of accumulations, the gain of the detector, the averaging of the signals.

These parameters are, for example, as follows:

TABLE II

| | Sample | Reference |
|---|---|---|
| Measurement delay relative to the laser | 1 μs | Not |
| shot | | applicable |
| Width of the acquisition temporal gate | 500 ns | 200 ms |
| Number and rate of accumulations | 20 to 20 Hz | 10 to 3 Hz |
| Gain of the detector | 3,000 | 3,000 |
| Signal averaged over . . . | 10 | 1 |
| | acquisitions | acquisition |

According to one embodiment, the system 10 according to the invention is adapted to measure a sample signal originating from a plasma, as illustrated in FIG. 8. According to one embodiment, the system further comprises a pulsed laser 1 configured to illuminate the sample so as to generate the plasma PI able to emit the light signal SLech originating from the sample. It also comprises an optical fiber FOp configured so that the input collects either a light signal originating from the sample or a light signal originating from the reference source, and its output S is coupled to an input of the spectrometer Spectro.

The processing unit UT is configured to synchronize the detector Det with the laser L upon detection of the measured profile of interest.

Preferably, the system 10 comprises, in addition to the laser L, an optic 2 that focuses the laser beam onto the sample, and an optical system SO configured to inject a portion of the light signal originating from the sample into the input E of the optical fiber.

According to one embodiment, the system 10 according to the invention is adapted to measure an isotope ratio of an element present in the sample. The central wavelength of interest then corresponds to a line resulting from contributions of two isotopes of the element, with the value of the central wavelength of interest allowing the isotopic abundance to be determined.

Results are briefly provided hereafter that illustrate the advantage of the framing correction method. A Jobin Yvon THR1000 spectrometer with a 2,400 line/mm grating centered at 670 nm is used. The detector is an Andor iStar 2048×512 pixel intensified camera, with a linear dispersion DL of 2.774 pm/pixel at 670 nm.

A line of a mercury vapor lamp is measured in the presence of drift in the spectrometer, the line of the mercury vapor source is the spectral line of interest.

Before and after detecting the spectral line of interest, the line of the reference source formed by a lithium hollow cathode lamp (HCL) is measured, which is precisely known, as equal to λref=670.776 nm.

The drift of the spectrometer is then corrected according to the method 100 according to the invention.

The acquisition parameters are provided in Table III below.

TABLE III

| Width of the acquisition temporal gate | 50 ms |
|---|---|
| Number and rate of accumulations | 100 to 18 Hz |
| Gain of the detector | 4,000 |

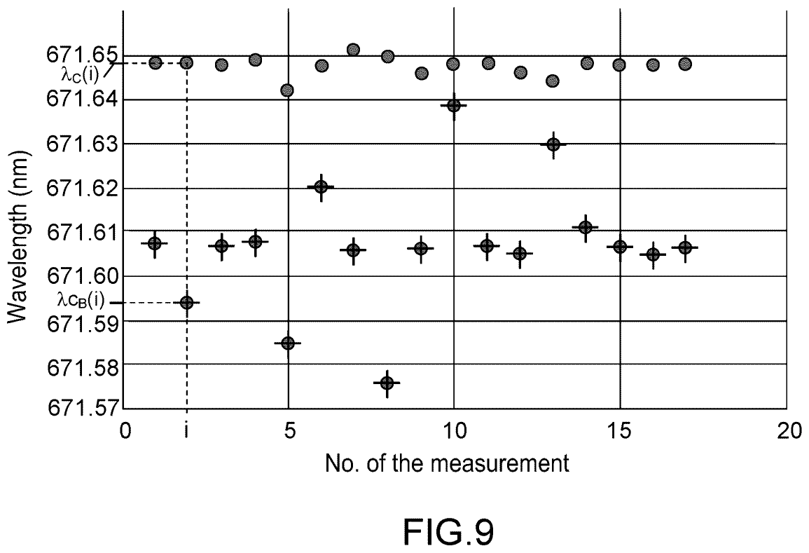

The graph of FIG. 9 illustrates the data that is obtained by repeating the measurement 17 times (measurements i numbered from 1 to 17). For each measurement i, on the one hand, a rough value λc_{B}(i) (cross) and, on the other hand, a corrected value λc(i) (dots), are determined according to the method 100 according to the invention. The rough values are obtained by a direct measurement with the detection system. The dispersion of the rough data is obvious and results from the drift of the spectrometer. The corrected values of λc are very sparingly dispersed over the 17 measurements.

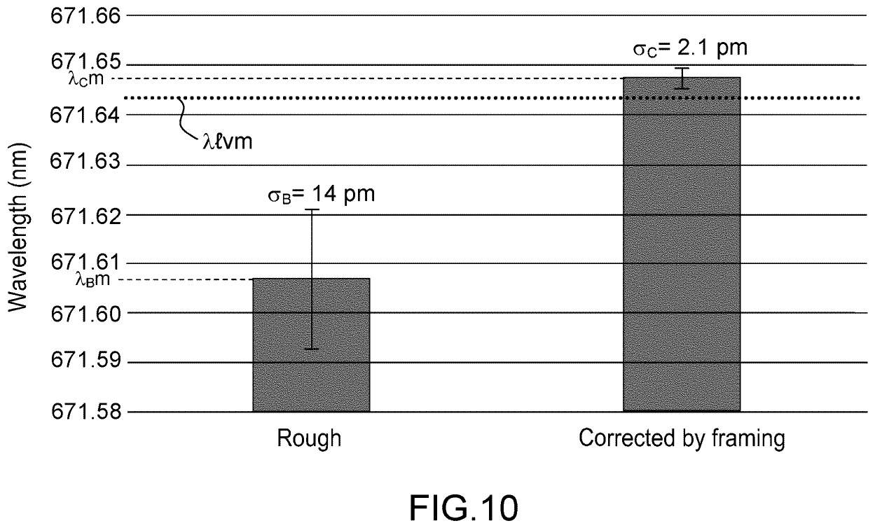

FIG. 10 shows the average and standard deviation α of these 17 measurements in both cases, rough and corrected with λref of the HCL lamp, respectively (λ_{B}m, σ_{B}) and (λ_{c}m, σ_{c}). The reference value, also very precisely known, of the wavelength of the mercury vapor lamp is λₗᵥₘ=671.643 nm. This value is also mentioned in FIG. 11 and allows the relevance of the method according to the invention to be tested. The value λ_{c}m is much closer to λₗᵥₘ than the value λ_{B}m. It follows that the measurement method according to the invention significantly improves the accuracy and the precision of the measured wavelength.

The bias for the two measurements is determined, that is:

$$[ 101 ] Bias ( rough measurements ) = {λ}_{lvm -} {λ}_{B} m = 35 pm ;$$

$$[ 102 ] Bias ( corrected measurements ) = {λ}_{lvm -} {λ}_{c} m = - 3 pm .$$

Then, the uncertainties I of the two measurements are deduced therefrom by applying the following formula:

I=\sqrt{(σ²+Bias²)} (5)

The uncertainty concerning the wavelength measurement thus changes from 38 pm for the rough measurement to 4 pm for the corrected measurement.

Table IV below specifies, in a measurement example (No. 5), the times t0, t1, t2, the measured positions in pixels P1ref, Pech, P2ref by adjusting the experimental data with theoretical curves, the coefficients a and b determined with formulas (3) and (4), the interpolated intermediate position P0ref, the wavelength of the reference source λref, and that of the measured source λc, before and after framing correction.

TABLE IV

| t1 (hh:min:ss) | 17:09:00 |
|---|---|
| t0 (hh:min:ss) | 17:09:24 |
| t2 (hh:min:ss) | 17:11:38 |
| a | 0.088 |
| b | 1028.985 |
| λref (nm) | 670.776 |
| P0ref (pixel) | 1031.088 |
| λc before correction (nm) | 671.585 |
| λc after correction (nm) | 671.642 |
| P1ref (pixel) | 1028.985 |
| Pech (pixel) | 1343.168 |
| P2ref (pixel) | 1028.965 |

1. A method for determining a central wavelength of interest (λc) of a spectral line of interest (RSe) measured by a spectrometer, the spectral line of interest corresponding to an emission or an absorption of a sample (Ech) to be characterized, the spectral line of interest having either a bell profile, with said central wavelength of interest then corresponding to the vertex of said bell profile, or a double bell profile, with said central wavelength of interest then corresponding to the trough between the two bells, the spectrometer being associated with a detector (Det) comprising a plurality of pixels (Pi) aligned in a direction X, the spectral line of interest being detected on pixels of the detector, the method comprising the following steps of:
A) detecting, at a time t1, a first reference measured profile (PS1ref) derived from a reference source (Sref) having a reference spectral line (RSref) having a central wavelength, called reference central wavelength, of known value (λref), the reference wavelength being selected so as to be detected on at least one pixel of the detector;
B) then detecting, at a time t0, a measured profile of interest (PSech) derived from said sample of interest;
C) then detecting, at a time t2, a second reference measured profile (PS2ref) derived from a reference source (Sref);
D) processing said first and second reference measured profiles so as to determine a first (P1ref) and a second (P2ref) reference position of the reference wavelength, and processing the measured profile of interest so as to determine a position of interest (Pech) of the central wavelength;
E) determining a reference position, called intermediate reference position (P0ref), at the time t0 by interpolation, based on the first and second reference positions, and based on a linear variation law of the reference position as a function of time between the times t1 and t2;
F) determining a value of the central wavelength of interest based on a difference between said positions of interest (Pech) and intermediate reference positions (P0ref), on said known value of the reference wavelength and on a linear dispersion (DL) of the spectrometer and of the associated detector.

2. The method as claimed in claim 1, wherein the processing step D comprises a sub-step of adjusting values of the measured profile of interest and the first and second reference measured profiles with known mathematical functions so as to determine said position of interest and said first and second reference positions by interpolation, with precision of less than one pixel, with the intermediate reference position then also being determined with precision of less than one pixel.

3. The method as claimed in claim 1, wherein the light signal originating from the sample is pulsed.

4. The method as claimed in claim 3, wherein the light signal originating from the sample originates from an emission of a plasma emitted by the sample illuminated by a pulsed laser.

5. The method as claimed in claim 4, adapted to determine an isotopic abundance of an element present in said sample, said central wavelength of interest corresponding to a line resulting from the contributions of two isotopes of said element, with said value of the central wavelength of interest allowing said abundance to be determined.

6. A system for measuring a central wavelength of interest (λc) of a spectral line of interest (RSe) measured by a spectrometer, the spectral line of interest corresponding to an emission or an absorption of a sample (Ech) to be characterized, the spectral line of interest having either a bell profile, with said central wavelength of interest then corresponding to the vertex of said bell profile, or a double bell profile, with said central wavelength of interest then corresponding to the trough between the two bells, the measurement system comprising:
a detection system comprising a spectrometer (Spectro) associated with a detector (Det) comprising a plurality of pixels (Pi) aligned in a direction X, the spectral line of interest being detected on pixels of the detector;
the system being configured so that the detector detects:
at a time t1, a first reference measured profile (PS1ref) derived from a reference source (Sref), the reference source (Sref) having a reference spectral line (RSref) having a central wavelength, called reference central wavelength, of known value (λref), the reference wavelength being selected so as to be detected on at least one pixel of the detector;
then, at a time t0, a measured profile of interest (PSech) derived from said sample of interest;
then, at a time t2, a second reference measured profile (PS2ref) derived from the reference source (Sref);
the system further comprising a processing unit (UT) configured to:
process said first and second reference measured profiles so as to determine a first (P1ref) and a second (P2ref) reference position of the reference wavelength, and process the measured profile of interest so as to determine a position of interest (Pech) of the central wavelength;
determine a reference position, called intermediate reference position (P0ref), at the time t0 by interpolation, based on the first and second reference positions, and based on a linear variation law of the reference position as a function of time between the times t1 and t2;
determine a value of the central wavelength of interest based on a difference between said positions of interest (Pech) and intermediate reference positions (P0ref), on said known value of the reference wavelength and on a linear dispersion (DL) of the detection system.

7. The measurement system as claimed in claim 6, further comprising:
a pulsed laser (L) configured to illuminate the sample so as to generate a plasma (PI) able to emit said light signal originating from the sample;
an optical fiber (FOp) configured so that the input collects either a light signal originating from the sample or a light signal originating from the reference source, and the output is coupled to an input of the spectrometer;
with the processing unit being configured to synchronize the detector with the laser when detecting the measured profile of interest.

8. The measurement system as claimed in claim 7, adapted for measuring the isotopic abundance of an element present in the sample, said central wavelength of interest corresponding to a line resulting from the contributions of two isotopes of said element, with said value of the central wavelength of interest allowing said isotopic abundance to be determined.

9. A non-transitory computer-readable storage medium on which is stored a computer program comprising instructions that causes a system to execute the steps of the method as claimed in claim 1.
